(19) United States
(12) Patent Application Publication
(10) Pub. No.: US 2015/0332238 A1
(43) Pub. Date: Nov. 19, 2015

(54) POS SYSTEM AND METHOD FOR DRIVING SAME

(71) Applicant: CNP Technology Co., Ltd., Seoul (KR)

(72) Inventor: Jeon Sub SHIN, Seoul (KR)

(21) Appl. No.: 14/394,093

(22) PCT Filed: Mar. 27, 2013
(86) PCT No.: PCT/KR2013/002531

§ 371 Date: Oct. 12, 2014

(30) Foreign Application Priority Data
Apr. 12, 2012 (KR) 10-2012-0038020

(51) Int. Cl. G06Q 20/20; H04L 29/06; G06Q 20/32; H04L 29/08

(52) U.S. Cl. CPC G06Q 20/202; H04L 67/10; H04L 63/08; G06Q 20/3278

(57) ABSTRACT

The POS system of the present invention can include a mobile terminal and a POS-supporting device which is connected to the mobile terminal via a near-field communication (NFC)-based relay so as to be in communication therewith. Here, the mobile terminal includes an open source-based POS application program module connected to the POS-supporting device in an NFC scheme via the relay so as to be in communication therewith, and interacting, through the relay, with the POS-supporting device and a server supporting a POS function on a communication network in order to perform POS functions. The POS system can autonomously manage itself by adjusting the POS application program without manufacturer support at the store or shop, and the POS system can be introduced and used at a low cost.

### TECHNICAL FIELD

The present invention relates to a POS system and a method for driving the same.

### BACKGROUND ART

A POS (Point of Sales System) generally means a sale point management system which has a cash receipt and payment registration function and a computer function. For example, the Korean Patent Publication No. 2004-0087586 describes an ordinary POS system.

When such a POS system is used, it is possible to recognize the sale flow of goods by basic items and recognize in details a sale trend and a sold time of new goods and promotion goods as well as a sale trend of poor sale goods, analogous goods or competing goods. A marketing strategy such as a correlation between a sale price and a sale quantity, a key marketing target, an advertisement planning, etc. can be therefore effectively established. In addition, a goods management system such as an inventory, an ordering, a delivery, etc. can be simplified and standardized, which contributes to the saving of prime cost.

Therefore, most of the shops or stores which make profits by selling goods are using such a POS system.

The above-described POS system comprises a database server which is generally configured to perform a goods management, a sale management, etc., and a POS terminal which performs a variety of POS functions in cooperation with a server which supports the POS functions like the server of the VAN (Value Add Network) company which has a function for credit card payment. Here, the POS function comprises a function for collecting and processing a variety of information and data which are necessary for the sake of a goods management, a payment process, a sale amount calculation process and a shop and a store administration.

The construction of the related POS terminal will be described. In a single body, POS peripherals and a POS computer are integrally and communicatively connected through a cable. The POS peripheral comprises a cash storing container, a MSR (Magnetic Stripe Reader) card reader, a card payment signing pad, a code scanner for scanning a goods identification code such as a barcode or QR code, a bill/receipt printer, etc. The POS computer comprises a UI (User Interface) such as a keyboard, a monitor and a mouse which are generally used as the peripherals of a computer. A POS application program is installed to perform a POS function in cooperation with the server which supports the windows-based operating system and POS peripherals, UI and POS functions.

Some companies developed and now have the exclusive copyright on the conventional POS system and use the POS terminals wherein the closed source-based POS application program with a high development level is installed. So, if the POS terminal has a problem during the operation due to an error at the POS application program, such problem should be resolved only with the aid of a specific company. Therefore, inconvenience occurs during the management of the POS system, and a cost is necessary in exchange for the cooperation of such a specific company.

The POS terminal belonging to the conventional POS system is manufactured in such a way that the POS computer and all the POS peripherals are integrally connected, which results in increased consumer price. For the owner of the shop or the store who wants to buy the POS system, it is necessary to buy the POS terminals by paying a high cost even when the unnecessary POS peripherals are mounted.

### DISCLOSURE OF INVENTION

### Technical Problem

According to one aspect of the present invention, there are provided a POS system and a method for driving the same which make it possible to implement a POS function by cooperating mobile terminals on which an open source-based POS application program module is mounted, with a specific POS peripheral under a wireless communication environment.

### Solution to Problem

The POS system according to an exemplary embodiment of the present invention comprises a mobile terminal; and a POS-supporting device which is communicatively connected to the mobile terminal through a near field communication-based repeater, wherein the mobile terminal includes an open source-based POS application program which communicatively connected through the repeater to the POS-supporting device by a near field communication method and performs a POS function through the repeater in cooperation with the POS-supporting device and a server configured to support the POS function on the communication network.

The POS-supporting device according to an exemplary embodiment comprises a near field communication unit which performs a communication with a repeater by a near field communication method; an authentication information storing unit which stores a user list wherein a connection authentication information of a mobile terminal is registered so as to allow/block a communication connection; a connection process unit which receives a connection authentication information from the mobile terminal when a connection request is received through the near field communication unit the mobile terminal, and determines whether the connection authentication has succeeded or not depending on whether the received connection authentication information is registered on the user list or not and allows a communication connection to the mobile terminal which has succeeded in the connection authentication; an authentication key generation unit which generates a connection terminal identification authentication key when the connection authentication of the mobile terminal has succeeded by the connection process unit and provides, through the near field communication unit, the generated connection terminal identification authentication key to the mobile terminal which has succeeded in the connection authentication; an authentication key storing unit which matches the connection terminal identification authentication key generated by the authentication key generation unit with the connection authentication information of the mobile terminal which has succeeded in the connection authentication, among the connection authentication information registered in the user list stored in the authentication information storing unit and stores the connection authentication information; an instrument driving unit which drives the POS peripherals based on the command or control-related data received from the mobile terminal; and a data process unit which confirms whether the received data contains the authentication key stored in the authentication key storing unit or not when the command or control-related data is received from the mobile terminal through the near field communication unit and transfers the command or control-related data, which is received from the mobile terminal, to the instrument driving unit only when the authentication key is contained in the received data as a result of the confirmation.

The method for driving a POS system according to an exemplary embodiment of the present invention comprises a communication connection step wherein the mobile terminal is communicatively connected to the POS-supporting device through the repeater; a step wherein the POS-supporting device generates a connection terminal identification authentication key and provides the generated connection terminal identification authentication key to the mobile terminal; a step wherein the mobile terminal transmits the command or control-related data containing the connection terminal identification authentication key to the POS-supporting device; a step wherein the POS peripherals are driven based on the command or control-related data when the POS-supporting device confirms whether the connection terminal identification authentication key is the previously stored authentication key or not and then as a result of the confirmation, when the connection terminal identification authentication key is the previously stored authentication key; and a step wherein a result of the driving is transmitted to the mobile terminal as a response data.

### Advantageous Effects

According one aspect of the present invention, the POS system and a method for driving the same are characterized in that a mobile terminal on which an open source-based POS application program module is mounted is configured to operate in cooperation with a specific POS peripheral under a wireless communication environment, so the POS system may be managed at a shop or a store by controlling the POS application program itself without any cooperation from a manufacturer, for which it is possible to purchase and use a POS system at a low cost.

### BRIEF DESCRIPTION OF DRAWINGS

FIG. 1 is a schematic view illustrating a construction of a POS system according to an exemplary embodiment of the present invention.

FIG. 2 is a schematic view illustrating a construction of a POS-supporting device of FIG. 1.

FIG. 3 is a flow chart for describing a method for driving a POS system according to an exemplary embodiment of the present invention.

### BEST MODES FOR CARRYING OUT THE INVENTION

The exemplary embodiments of the present invention will be described with reference to the accompanying drawings.

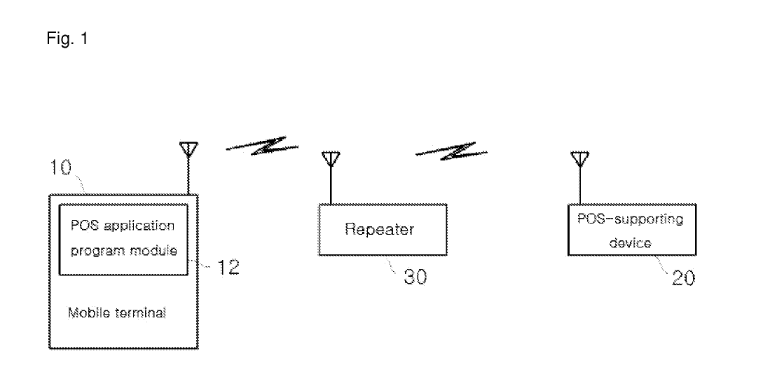

FIG. 1 is a schematic view illustrating a construction of a POS system according to an exemplary embodiment of the present invention.

As illustrated in FIG. 1, the POS system according to an exemplary embodiment of the present invention comprises a mobile terminal 10, a POS-supporting device 20 and a repeater 30.

The mobile terminal 10 comprises an open source-based POS application program module 12 which connects, through a repeater 30, the mobile terminal 10 and the POS-supporting device 20 by means of a near field communication. The mobile terminal 10 is a near field communication-based smart type terminal which can install a POS application program module 12 such as an open source-based application, etc. and may be any of a smart phone, a tablet PC, a smart pad, a lap-top, etc.

The POS application program module 12 performs, using connection authentication information, a communication connection procedure between the mobile terminal 10 and the repeater 30. Thereafter, the POS application program module 12 performs a communication connection procedure with the POS-supporting device 20 through the repeater 30 using the connection authentication information when the mobile terminal 10 is communicatively connected to the repeater 30.

The connection authentication information includes at least one of a MAC/IP address, a serial number of the mobile terminal 10, an exclusive identification code of the POS application program module 12 and a login information. Here the MAC/IP address may be formed of a fixed MAC/IP address that the POS application program module 12 has obtained by connecting to the internet through a cooperation with the web browser mounted on the mobile terminal 10. In addition, the login information may be an ID, a password, etc. that the POS application program module 12 has received through the UI mounted on the mobile terminal 10 from the user.

In addition, the POS application program module 12 performs a POS function in cooperation with the POS-supporting device 20 through the repeater 30 as a connection is connected through the repeater 30 between the mobile terminal 10 and the POS-supporting device 20 and also in cooperation with the server which supports the POS function on the communication network through the repeater 30. At this time, the communication network may be formed of any of Ethernet, Internet and Intranet.

In addition, in case that the POS application program module 12 operates in cooperation with the POS-supporting device 20 through the repeater 30, the POS application program module 12 performs a data transmission and receiving procedure for transmitting a command or control-related data and receiving a response data. At this time, it is preferred that the POS application program module 12 transmits the transmission data by including a connection terminal identification authentication key provided from the POS-supporting device 20 into the transmission data. The above-described command or control-related data may include any of a printer command, a card reading command, an electronic tag reading command and a specific peripheral control command. In addition, the response data may include any of a card reading information, an electron tag reading information and a command/control process result information (printing completion, etc.).

When the POS application program module 12 transmits or receives the data through the repeater 30 between the POS-supporting devices 20, an AES or 3-DES is used for the sake of the security of the data in such a way to encode or decode the transmission and receiving data. Here, the transmission and receiving data may be formed in a packet structure which includes a STX (Start of Text), Command, Length, Coded Data and ETX (End of Text) region, etc.

The POS-supporting device 20 is configured to connect a communication between the POS peripherals and the mobile terminal 10 in cooperation with the POS application program module 12 mounted on the mobile terminal 10 through the repeater 30. Here, the POS peripheral includes a cash storing container, a MSR card reader, a card payment signing pad, a code scanner for scanning a goods identification code such as a bar code or a QR code, a reader based on a Near Field communication (NFC) designed to read an IC chip/electronic tag embedded in a goods/card, a bill/receipt printer, etc.

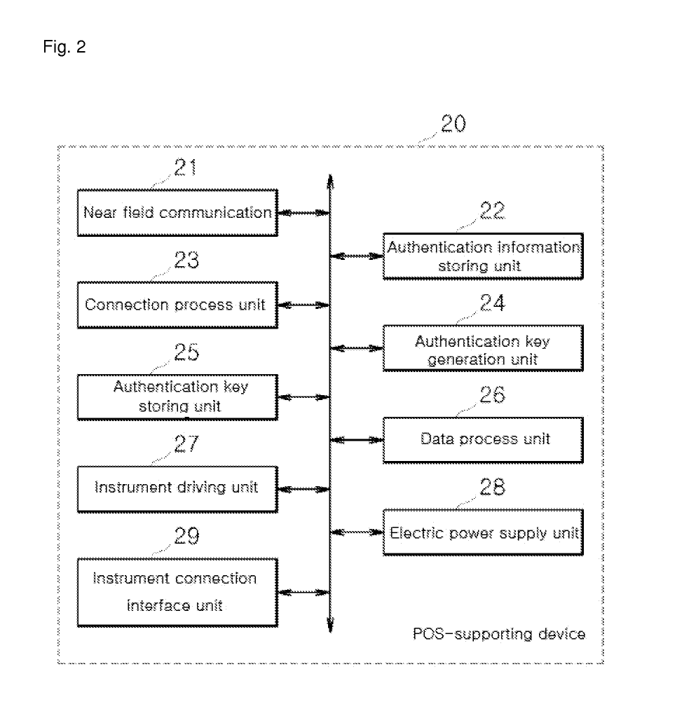

FIG. 2 is a schematic view illustrating the configuration of a POS-supporting device of FIG. 1.

Referring to FIG. 2, the POS-supporting device 20 comprises a near field communication unit 21, an authentication information storing unit 22, a connection process unit 23, an authentication key generation unit 24, an authentication key storing unit 25, a data process unit 26, an instrument driving unit 27 and an electric power supply unit 28. The near field communication unit 21, the authentication information storing unit 22, the connection process unit 23, the authentication key generation unit 24, the authentication key storing unit 25, the data process unit 26, the instrument driving unit 27 and the electric power supply unit 28 may be all installed or mounted on the body of the POS-supporting device 20 along with part of the POS peripherals. At this time, the part of the POS peripherals may include a MSR card reader and a reader based on a near field communication which is configured to read an IC chip/electronic tag, a bill/receipt printer, etc.

The near field communication unit 21 performs a near field communication-based communication with the repeater 30.

The near field communication unit 21 may be implemented with any of a UWB module, a WLAN module, a WiMAX module, an infrared ray (IR) module, a RFID module, a Bluetooth module, a Zigbee module, a WIFI module, etc.

The authentication information storing unit 22 stores a user list wherein a connection authentication information of the mobile terminal 10 is stored for allowing or blocking the communication connection. Such an authentication information storing unit 22 may receive a user list from a specific server having the user list through the near field communication unit 21, the repeater 30 and the communication network and may store the user list or may update the previously stored user list.

When a connection request is requested from the mobile terminal 10 through the near field communication unit 21, the connection process unit 23 performs a connection authentication procedure with the mobile terminal 10. At this time, during the connection authentication procedure with the mobile terminal 10, the connection process unit 23 requests a connection authentication information to the mobile terminal 10 and receives a connection authentication information from the mobile terminal 10. In addition, the connection authentication success of the mobile terminal 10 is determined based on whether the received authentication information is registered at the user list of the authentication information storing unit 22 or not. The connection authentication process unit 23, as a result of the judgment, allows a communication connection of the mobile terminal 10 which successfully has passed the connection authentication.

The authentication key generation unit 24 generates a connection terminal identification authentication key when the mobile terminal 10 succeeds in the connection authentication by means of the connection process unit 23 and provides the generated connection terminal identification authentication through the near field communication unit 21 to the mobile terminal 10 which has succeeded in the connection authentication.

The authentication key storing unit 25 matches the connection terminal identification authentication key generated by the authentication key generation unit 24 with the connection authentication information of the mobile terminal 10 which has succeeded in the connection authentication, among the connection authentication information registered in the user list stored in the authentication information storing unit 22.

The instrument driving unit 27 drives the POS peripherals based on the command or control-related data received from the mobile terminal 10.

When a command or control-related data is received through the near field communication unit 21 from the mobile terminal 10, the data process unit 26 confirms whether the received data contains an authentication key stored in the authentication key storing unit 25 or not, and as a result of the confirmation, if contained, the data process unit 26 transfers the command or control-related data received from the mobile terminal 10, to the instrument driving unit 27.

In addition, the data process unit 26 transmits a result after the instrument driving unit 27 has driven the POS peripherals based on the command or control-related data received from the mobile terminal 10, to the mobile terminal 10 through the near field communication 21 as a response data with respect to the command or control-related data receiving from the mobile terminal 10.

Also, the data process unit 26 encodes or decodes the transmission and receiving data using the AES or 3-DES, etc. for the sake of data security when the data is transmitted or received with the mobile terminal 10 through the near field communication unit 21.

The electric power supply unit 28 supplies operation electric power to the near field communication unit 21, the authentication information storing unit 22, the connection process unit 23, the authentication key generation unit 24, the authentication key storing unit 25, the data process unit 26 and the instrument driving unit 27, respectively.

In addition, the POS-supporting device 20 may further comprise an instrument connection interface unit 29. For example, the instrument connection interface unit 29 may be formed of pluralities of USB ports and RS232C ports, etc. for the sake of communications between the POS peripherals and the instrument driving unit 7 except for part of the peripherals installed and mounted on the body of the POS-supporting device 20. In addition, there may be further provided a charging USB port, etc. configured to transfer the electric power from the electric power supply unit 28 through a USB cable to the mobile terminal 10. At this time, it is preferred that the POS-supporting device 20 may further include an electric power converter which is configured to convert the electric power from the electric power supply unit 28 into a charging electric power of the mobile terminal 10 and supply to the charging USB port.

In addition, the repeater 30 is configured to repeat communications between the communication network to which the database server and various servers are connected, the mobile terminal 10 and the POS-supporting device 20. Such a repeater 30 includes an access point (AP) based on the near field communication implemented by UWB, WLAN, WiMAX, an infrared ray (IR), RFID, Bluetooth, Zigbee, WIFI, etc.

When a connection request is received from the mobile terminal 10, the repeater 30 performs a connection authentication procedure with the mobile terminal 10. At this time, while performing the connection authentication procedure with the mobile terminal 10, the repeater 30 request a connection authentication information to the mobile terminal 10 and receives a connection authentication information from the mobile terminal 10. In addition, the connection authentication success of the mobile terminal 10 is determined depending on a result of whether the received connection authentication information is registered in the user list stored in the internal memory region or not. The repeater 30 allows a communication connection to the mobile terminal 30 which successfully has passed the connection authentication.

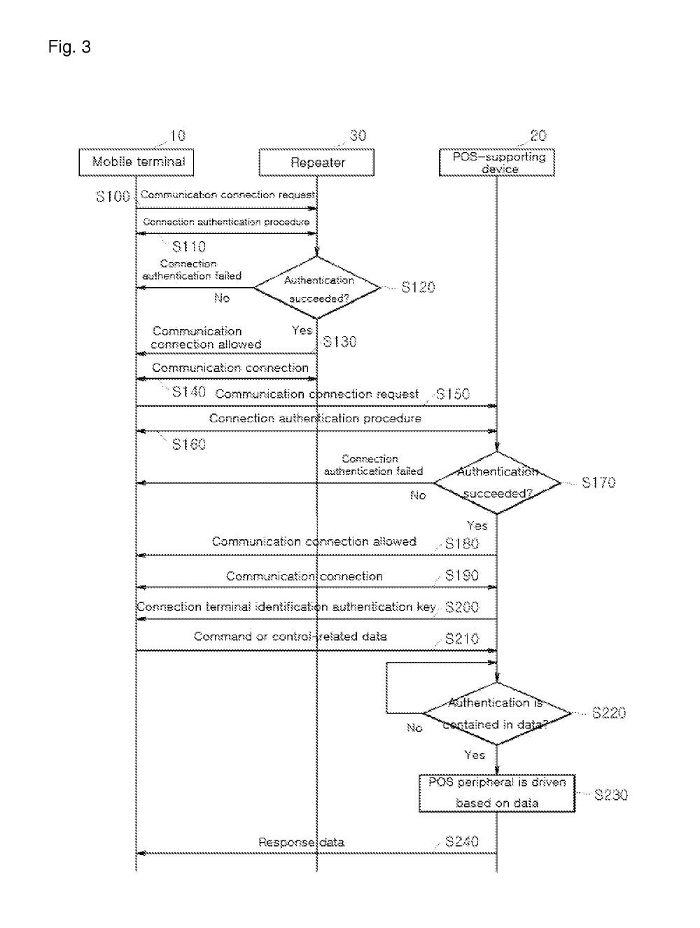

In the above-described construction, the method for driving the POS system according to an exemplary embodiment of the present invention will be described with reference to FIG. 3.

First, when the mobile terminal 10 requests the repeater 30 a communication connection (S100), the repeater 30 performs a connection authentication procedure with the mobile terminal 10 (S110). When the mobile terminal 10 succeeds in a connection authentication (S120), the communication connection of the mobile terminal 10 is allowed (S130), and a communication with the mobile terminal 10 is connected (S140). As a result of the connection authentication procedure in the step S110, if the connection authentication of the mobile terminal 10 fails, it is preferred that the failure of the connection authentication is reported to the mobile terminal 10.

After the step S140, when the mobile terminal 10 requests the POS-supporting device 20 a communication connection through the repeater 30 (S150), the POS-supporting device 20 performs a connection authentication procedure with the mobile terminal 10 (S160). In addition, if the mobile terminal 10 succeeds in the connection authentication (S170), the communication connection of the mobile terminal 10 is allowed (S180), and a communication with the mobile terminal 10 through the repeater 30 is allowed (S190). As a result of the connection authentication procedure in the step S160, if the connection authentication of the mobile terminal 10 fails, it is preferred that the failure of the connection authentication is reported to the mobile terminal 10.

Following the step S190, the POS-supporting device 20 generates a connection terminal identification authentication key and provides to the mobile terminal 10 which has succeeded the connection authentication in the step S170 (S200).

In the step S200, the connection terminal identification authentication key is used so as to recognize the command or control-related data received from a plurality of the mobile terminals 10 communicatively connected to the POS-supporting device 20 or to recognize the command or control-related data received from the mobile terminal 10 communicatively connected to the POS-supporting device 20 by an abnormal procedure or method such as a backdoor hacking, etc.

Following the step S200, the mobile terminal 10 transmits a command or control-related data including a connection terminal identification authentication key to the POS-supporting device (S210).

The POS-supporting device 20 which has received the command or control-related data in the step S210 confirms whether the received data contains the previously stored authentication key or not (S220). As a result of the confirmation, if the authentication key is the previously stored authentication key, the POS peripheral is driven based on the data received in the step S210 (S230), and a result of the driving is transmitted as a response data to the mobile terminal 10 (S240).

Namely, following the step S200, the POS application program module 12 mounted on the mobile terminal 10 operates in cooperation with the POS-supporting device 20 in the S210 to S240 and is connected through the repeater 30 to the communication network connected to the server which supports the POS function for thereby performing a variety of POS functions.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

### INDUSTRIAL APPLICABILITY

The exemplary embodiments are directed to a POS system and a method for driving the POS system.

1. A POS system, comprising:
a mobile terminal; and
a POS-supporting device which is communicatively connected to the mobile terminal through a near field communication-based repeater,
wherein the mobile terminal includes an open source-based POS application program which communicatively connected through the repeater to the POS-supporting device by a near field communication method and performs a POS function through the repeater in cooperation with the POS-supporting device and a server configured to support the POS function on the communication network.

2. The system of claim 1, wherein the POS application program module is configured to perform, using a connection authentication information, a communication connection procedure between the mobile terminal and the repeater and performs through the repeater a communication connection procedure with the POS-supporting device using the connection authentication information when the mobile terminal is communicatively connected to the repeater.

3. The system of claim 2, wherein the repeater performs a connection authentication procedure with the mobile terminal by receiving a connection authentication information from the mobile terminal when a connection request is received from the mobile terminal and allows a communication connection to the mobile terminal which has succeeded in the connection authentication.

4. The system of claim 2, wherein the connection authentication information comprises at least one among a MAC/IP address, a serial number of the mobile terminal, an exclusive identification code of a POS application program module and a login information.

5. The system of claim 1, wherein when a command or control-related data is transmitted to the POS-supporting device, the POS application program module transmits the command or control-related data by adding a connection terminal identification authentication key to the command or control-related data received from the POS-supporting device when operating in cooperation with the POS-supporting device through the repeater.

6. The system of claim 1, wherein the POS application program module and the POS-supporting device encode and decode the transmission and receiving data for the sake of data security when transmitting and receiving the data through the repeater.

7. A POS-supporting device, comprising:
a near field communication unit which performs a communication with a repeater by a near field communication method;
an authentication information storing unit which stores a user list wherein a connection authentication information of a mobile terminal is registered so as to allow/block a communication connection;
a connection process unit which receives a connection authentication information from the mobile terminal when a connection request is received through the near field communication unit the mobile terminal, and determines whether the connection authentication has succeeded or not depending on whether the received connection authentication information is registered on the user list or not and allows a communication connection to the mobile terminal which has succeeded in the connection authentication;
an authentication key generation unit which generates a connection terminal identification authentication key when the connection authentication of the mobile terminal has succeeded by the connection process unit and provides, through the near field communication unit, the generated connection terminal identification authentication key to the mobile terminal which has succeeded in the connection authentication;
an authentication key storing unit which matches the connection terminal identification authentication key generated by the authentication key generation unit with the connection authentication information of the mobile terminal which has succeeded in the connection authentication, among the connection authentication information registered in the user list stored in the authentication information storing unit and stores the connection authentication information;
an instrument driving unit which drives the POS peripherals based on the command or control-related data received from the mobile terminal; and
a data process unit which confirms whether the received data contains the authentication key stored in the authentication key storing unit or not when the command or control-related data is received from the mobile terminal through the near field communication unit and transfers the command or control-related data, which is received from the mobile terminal, to the instrument driving unit only when the authentication key is contained in the received data as a result of the confirmation.

8. The apparatus of claim 7, further comprising:
an instrument connection interface unit configured to connect a communication between the POS peripherals and the instrument driving unit.

9. A method for driving a POS system, comprising:
a communication connection step wherein the mobile terminal is communicatively connected to the POS-supporting device through the repeater;
a step wherein the POS-supporting device generates a connection terminal identification authentication key and provides the generated connection terminal identification authentication key to the mobile terminal;
a step wherein the mobile terminal transmits the command or control-related data containing the connection terminal identification authentication key to the POS-supporting device;
a step wherein the POS peripherals are driven based on the command or control-related data when the POS-supporting device confirms whether the connection terminal identification authentication key is the previously stored authentication key or not and then as a result of the confirmation, when the connection terminal identification authentication key is the previously stored authentication key; and
a step wherein a result of the driving is transmitted to the mobile terminal as a response data.

10. The method of claim 9, wherein the communication connection step comprises:
a step wherein the mobile terminal requests a communication connection to the repeater;
a step wherein when the connection authentication has been succeeded after the repeater performs a connection authentication procedure with the mobile terminal, the communication connection of the mobile terminal is allowed;
a step wherein the mobile terminal requests a communication connection to the POS-supporting device through the repeater which has allowed the communication connection; and
a step wherein the communication connection of the mobile terminal is allowed when the connection authentication has succeeded after the POS-supporting device performs a connection authentication procedure with the mobile terminal.

11. The system of claim 3, wherein the connection authentication information comprises at least one among a MAC/IP address, a serial number of the mobile terminal, an exclusive identification code of a POS application program module and a login information.
